(19) United States
(12) Patent Application Publication
(10) Pub. No.: US 2015/0015548 A1
(43) Pub. Date: Jan. 15, 2015

(54) TOUCH STYLUS AND OPERATING METHOD THEREOF

(71) Applicant: Raydium Semiconductor Corporation, Hsinchu (TW)

(72) Inventors: Wei-Yuan Cheng, Taichung City (TW); Te-Chang Lin, Hsinchu City (TW); Chia-Hsiu Lin, Hsinchu City (TW)

(21) Appl. No.: 14/322,424

(22) Filed: Jul. 2, 2014

(30) Foreign Application Priority Data
Jul. 9, 2013 (TW) 102124558

(51) Int. Cl. G06F 3/0354

(52) U.S. Cl. CPC G06F 3/03545
USPC 345/179

(57) ABSTRACT

A touch stylus and operating method thereof are disclosed. The touch stylus includes a power supply, a pressure sensing unit, a signal processing unit, and an output unit. The power supply is used to generate a constant current. The pressure sensing unit is coupled to the power supply and includes a changeable resistor. When the touch stylus touches a panel, the pressure sensing unit senses a pressure the panel provides to the touch stylus. A resistance of the changeable resistor is changed by the pressure, and an output voltage is generated in a voltage-dividing way. The signal processing unit is coupled to the pressure sensing unit and used to process the output voltage to generate an output signal. The output unit is coupled to the signal processing unit and used to output the output signal.

### BACKGROUND OF THE INVENTION

1. Field of the Invention

This invention relates to a touch input apparatus, especially to a touch stylus and an operating method thereof.

2. Description of the Related Art

In general, an electromagnetic induction inputting technology is used in a conventional touch stylus. In the conventional touch stylus, an oscillation circuit is cooperated with a signal emitter and an adjusting mechanism to continuously emit an electromagnetic signal. In this kind of touch stylus, there is usually a battery to provide power to emit stronger electromagnetic signal. No matter the touch stylus is located near a digitizer, the touch stylus will continuously emit electromagnetic signals of specific frequency and the strength of the emitted electromagnetic signals will be kept the same.

However, the conventional stylus has following drawbacks of: (1) high power consumption because of the electromagnetic signals of specific frequency continuously emitted by the touch stylus; (2) the electromagnetic signals being easily interfered; and (3) higher cost of the electromagnetic materials used in the touch stylus.

Therefore, the invention provides a touch stylus and an operating method thereof to solve the above-mentioned problems occurred in the prior arts.

### SUMMARY OF THE INVENTION

A scope of the invention is to provide a touch stylus capable of improving the problems of the electromagnetic signals being easily interfered and high power consumption and reducing its cost.

An embodiment of the invention is a touch stylus. In this embodiment, the touch stylus includes a power supply, a pressure sensing unit, a signal processing unit, and an output unit. The power supply is used to generate a constant current. The pressure sensing unit is coupled to the power supply and includes a changeable resistor. When the touch stylus touches a panel, the pressure sensing unit senses a pressure the panel provides to the touch stylus. A resistance of the changeable resistor is changed by the pressure, and an output voltage is generated in a voltage-dividing way. The signal processing unit is coupled to the pressure sensing unit and used to process the output voltage to generate an output signal. The output unit is coupled to the signal processing unit and used to output the output signal.

In an embodiment, the pressure sensing unit further includes a septum and a bottom electrode. When the touch stylus touches the panel, the septum is deformed by the pressure, and a gap between the septum and the bottom electrode is changed accordingly to cause a capacitance change. The pressure sensing unit senses the pressure according to the capacitance change.

In an embodiment, the pressure sensing unit further includes a piezoelectric material. When the touch stylus touches the panel, the piezoelectric material is deformed by the pressure to generate a voltage. The pressure sensing unit senses the pressure according to the voltage.

In an embodiment, the pressure sensing unit further includes a piezoresistive material. When the touch stylus touches the panel, the piezoresistive material is deformed by the pressure to generate a resistance change. The pressure sensing unit senses the pressure according to the resistance change.

In an embodiment, the pressure sensing unit further includes a gear and a slider. When the touch stylus touches the panel, the gear is pushed by the pressure to do a linear motion or a rotational motion to change the resistance of the changeable resistor, the slider and the changeable resistor are combined to generate the output voltage in the voltage-dividing way at a terminal coupled to the slider.

Another embodiment of the invention is a method of operating a touch stylus. In this embodiment, the touch stylus includes a power supply, a pressure sensing unit, a signal processing unit, and an output unit. The pressure sensing unit includes a changeable resistor. The method includes steps of: (a) the power supply generating a constant current; (b) when the touch stylus touches a panel, the pressure sensing unit sensing a pressure that the panel provides to the touch stylus, wherein a resistance of the changeable resistor is changed by the pressure to generate an output voltage in a voltage-dividing way; (c) the signal processing unit processing the output voltage to generate an output signal; and (d) the output unit outputting the output signal.

Compared to the prior art, the touch stylus and the touch stylus operating method of the invention have advantages of: (1) solving the power consumption problem by not continuously emitting the electromagnetic signal; (2) using non-electromagnetic signals to avoid signal interferences; (3) using no electromagnetic material to reduce the cost of the touch stylus.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a functional block diagram of the touch stylus in an embodiment of the invention.

FIG. 2 illustrates an embodiment of the touch stylus in the invention.

FIG. 3, FIG. 4, and FIG. 5 illustrate schematic diagrams of touch styluses having different types of pressure sensing unit.

FIG. 6 illustrates a flow chart of the touch stylus operating method in another embodiment of the invention.

### DETAILED DESCRIPTION

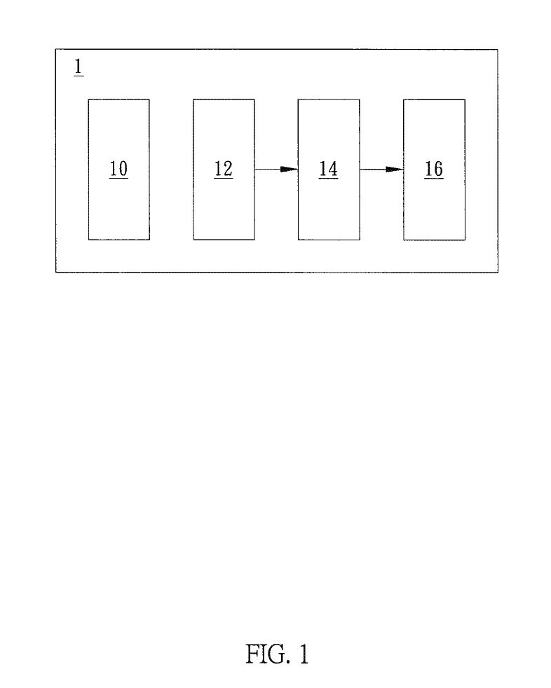

A preferred embodiment of the invention is touch stylus. In this embodiment, the touch stylus is used to perform a touch action on a touch panel of an electronic apparatus, but not limited to this. Please refer to FIG. 1. FIG. 1 illustrates a functional block diagram of the touch stylus in this embodiment.

As shown in FIG. 1, the touch stylus 1 includes a power supply 10, a pressure sensing unit 12, a signal processing unit 14, and an output unit 16. Wherein, the pressure sensing unit 12 is coupled to the power supply 10; the signal processing unit 14 is coupled to the pressure sensing unit 12; the output unit 16 is coupled to the signal processing unit 14.

In this embodiment, the power supply 10 is a constant current source for generating a constant current. In fact, the power supply 10 can be a current mirror or any other kinds of constant current source without any limitations.

The pressure sensing unit 12 includes a changeable resistor. When the touch stylus 1 touches the panel, the pressure sensing unit 12 will sense a pressure that the panel provides to the touch stylus 1. Because a resistance of the changeable resistor will be changed by the pressure, an output voltage generated by the pressure sensing unit 12 in a voltage-dividing way will be also changed.

The signal processing unit 14 is used to receive the output voltage from the pressure sensing unit 12 and process the output voltage to generate an output signal, and the output signal will be outputted through the output unit 16.

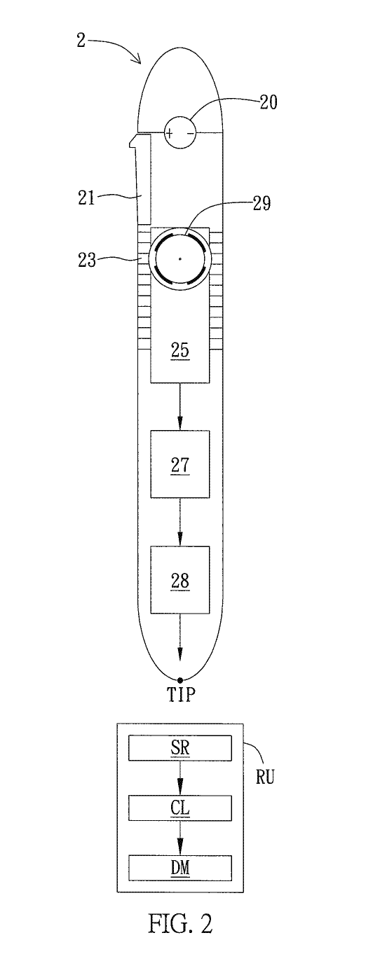

Please refer to FIG. 2. FIG. 2 shows an embodiment of the touch stylus in the invention. As shown in FIG. 2, the touch stylus 2 includes a power supply 20, a switch 21, a gear 23, a changeable resistor 25, an amplifier 27, a modulator 28, and a slider 29. Wherein, the gear 23, the changeable resistor 25, and the slider 29 belong to a pressure sensing unit. A receiver unit RU corresponding to the touch stylus 2 includes a sensor SR, a controller CL, and a demodulator DM.

When the switch 21 is turned on, the power supply 20 provides a constant current. When the touch stylus 2 touches the panel, the panel will provide a pressure on the touch stylus 2, so that the gear 23 in the touch stylus 2 will be pushed by the pressure to do a linear motion or a rotational motion to change the resistance of the changeable resistor 25. The slider 29 and the changeable resistor 25 are combined to generate an output voltage in the voltage-dividing way at a terminal coupled to the slider 29.

If the resistance distribution on the changeable resistor 25 is uniform, the slider 29 does the linear motion, and the output terminal is open-circuit, the output voltage can represent the motion amount of the slider 29. Then, the output voltage is amplified by the amplifier 27 and processed by the modulator 28 to generate an output signal, and a tip TIP of the touch stylus 2 will output the output signal.

When the tip TIP of the touch stylus 2 touches the receiver unit RU, the sensor SR senses the output signal, and then the controller CL and the demodulator DM process the output signal, the receiver unit RU will receive the output signal emitted by the tip TIP of the touch stylus 2.

It should be noticed that the pressure sensing unit 12 of the touch stylus 1 can be any type of pressure sensor, such as a capacitive pressure sensor, a piezoelectric pressure sensor, or a piezoresistive pressure sensor, but not limited to this. Next, embodiments of the touch styluses 1 using different types of pressure sensors as their pressure sensing units 12 are introduced as follows.

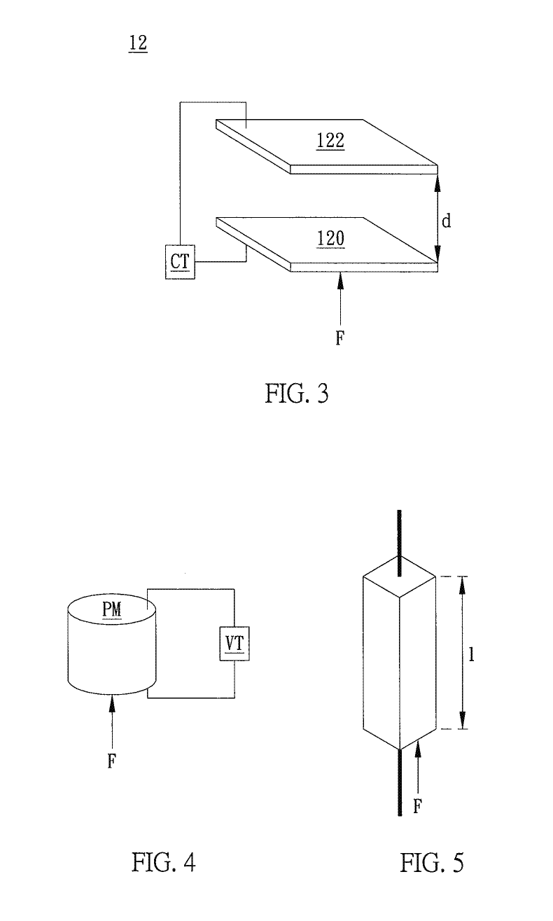

Please refer to FIG. 3. As shown in FIG. 3, the pressure sensing unit 12 of the touch stylus 1 is a capacitive pressure sensor. The pressure sensing unit 12 includes a septum 120 and a bottom electrode 122. When the touch stylus 1 touches the panel, the septum 120 will be deformed by the pressure F, and a gap d between the septum 120 and the bottom electrode 122 will be changed accordingly to cause a capacitance change between the septum 120 and the bottom electrode 122. A capacitance meter CT will measure the capacitance change between the septum 120 and the bottom electrode 122. The pressure sensing unit 12 will sense the pressure F provided by the panel when the touch stylus 1 touches the panel according to the capacitance change measured by the capacitance meter CT.

Please refer to FIG. 4. As shown in FIG. 4, the pressure sensing unit 12 of the touch stylus 1 is a piezoelectric pressure sensor. The pressure sensing unit 12 includes a piezoelectric material PM and a voltage meter VT. When the touch stylus 1 touches the panel, the piezoelectric material PM will be deformed by the pressure to generate a polarization to provide charges, so that the voltage meter VT coupled to two terminals of the piezoelectric material PM will measure a voltage between the two terminals of the piezoelectric material PM. The pressure sensing unit 12 will sense the pressure provided by the panel when the touch stylus 1 touches the panel according to the voltage measured by the voltage meter VT.

Please refer to FIG. 5. As shown in FIG. 5, the pressure sensing unit 12 of the touch stylus 1 is a piezoresistive pressure sensor. The pressure sensing unit 12 includes a piezoresistive material PR. When the touch stylus 1 touches the panel, the piezoresistive material PR will be deformed (e.g., the length of the piezoresistive is shortened) by the pressure to generate a resistance change. The pressure sensing unit can sense the resistance change caused by the pressure by using a method of providing a constant current passing through the piezoresistive material PR and measuring the voltage between two terminals of the piezoresistive material PR, or another method of providing a constant voltage between two terminals of the piezoresistive material PR and measuring the current passing through the piezoresistive material PR. The pressure sensing unit 12 will sense the pressure provided by the panel when the touch stylus 1 touches the panel according to the resistance change.

Another embodiment of the invention is a touch stylus operating method. In this embodiment, the touch stylus operating method is used to operate a touch stylus. The touch stylus includes a power supply, a pressure sensing unit, a signal processing unit, and an output unit. The pressure sensing unit includes a changeable resistor.

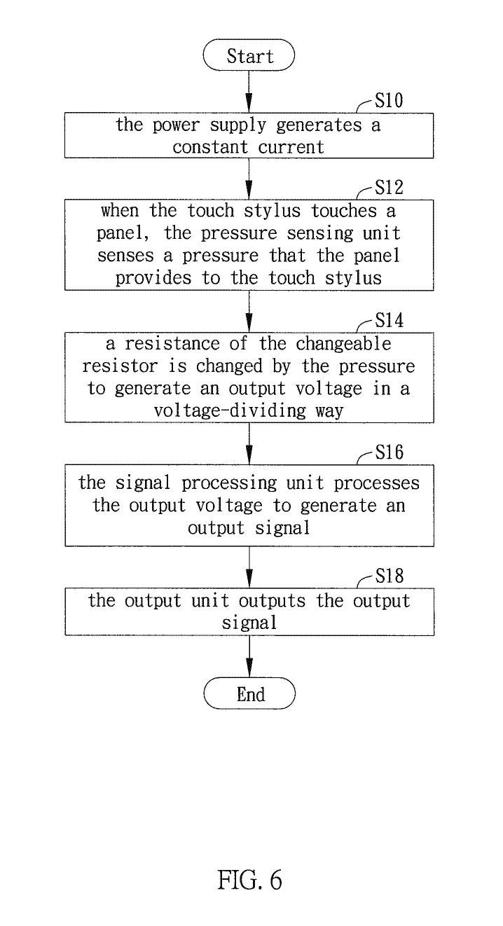

Please refer to FIG. 6. FIG. 6 illustrates a flow chart of the touch stylus operating method in the embodiment. As shown in FIG. 6, in the step S10, the power supply generates a constant current. In the step S12, when the touch stylus touches a panel, the pressure sensing unit senses a pressure that the panel provides to the touch stylus. In the step S14, a resistance of the changeable resistor is changed by the pressure to generate an output voltage in a voltage-dividing way. In the step S16, the signal processing unit processes the output voltage to generate an output signal. In the step S18, the output unit outputs the output signal.

Compared to the prior art, the touch stylus and the touch stylus operating method of the invention have advantages of: (1) solving the power consumption problem by not continuously emitting the electromagnetic signal; (2) using non-electromagnetic signals to avoid signal interferences; (3) using no electromagnetic material to reduce the cost of the touch stylus.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A touch stylus, comprising:
a power supply, for generating a constant current;
a pressure sensing unit, coupled to the power supply and comprising a changeable resistor, for sensing a pressure that a panel provides to the touch stylus when the touch stylus touches the panel, wherein a resistance of the changeable resistor is changed by the pressure to generate an output voltage in a voltage-dividing way;
a signal processing unit, coupled to the pressure sensing unit, for processing the output voltage to generate an output signal; and
an output unit, coupled to the signal processing unit, for outputting the output signal.

2. The touch stylus of claim 1, wherein the pressure sensing unit further comprises a septum and a bottom electrode, when the touch stylus touches the panel, the septum is deformed by the pressure, and a gap between the septum and the bottom electrode is changed accordingly to cause a capacitance change, the pressure sensing unit senses the pressure according to the capacitance change.

3. The touch stylus of claim 1, wherein the pressure sensing unit further comprises a piezoelectric material, when the touch stylus touches the panel, the piezoelectric material is deformed by the pressure to generate a voltage, the pressure sensing unit senses the pressure according to the voltage.

4. The touch stylus of claim 1, wherein the pressure sensing unit further comprises a piezoresistive material, when the touch stylus touches the panel, the piezoresistive material is deformed by the pressure to generate a resistance change, the pressure sensing unit senses the pressure according to the resistance change.

5. The touch stylus of claim 1, wherein the pressure sensing unit further comprises a gear and a slider, when the touch stylus touches the panel, the gear is pushed by the pressure to do a linear motion or a rotational motion to change the resistance of the changeable resistor, the slider and the changeable resistor are combined to generate the output voltage in the voltage-dividing way at a terminal coupled to the slider.

6. A method of operating a touch stylus, the touch stylus comprising a power supply, a pressure sensing unit, a signal processing unit, and an output unit, the pressure sensing unit comprising a changeable resistor, the method comprising steps of:
(a) the power supply generating a constant current;
(b) when the touch stylus touches a panel, the pressure sensing unit sensing a pressure that the panel provides to the touch stylus, wherein a resistance of the changeable resistor is changed by the pressure to generate an output voltage in a voltage-dividing way;
(c) the signal processing unit processing the output voltage to generate an output signal; and
(d) the output unit outputting the output signal.

7. The method of claim 6, wherein the pressure sensing unit further comprises a septum and a bottom electrode, when the touch stylus touches the panel, the septum is deformed by the pressure, and a gap between the septum and the bottom electrode is changed accordingly to cause a capacitance change, the pressure sensing unit senses the pressure according to the capacitance change.

8. The method of claim 6, wherein the pressure sensing unit further comprises a piezoelectric material, when the touch stylus touches the panel, the piezoelectric material is deformed by the pressure to generate a voltage, the pressure sensing unit senses the pressure according to the voltage.

9. The method of claim 6, wherein the pressure sensing unit further comprises a piezoresistive material, when the touch stylus touches the panel, the piezoresistive material is deformed by the pressure to generate a resistance change, the pressure sensing unit senses the pressure according to the resistance change.

10. The method of claim 6, wherein the pressure sensing unit further comprises a gear and a slider, when the touch stylus touches the panel, the gear is pushed by the pressure to do a linear motion or a rotational motion to change the resistance of the changeable resistor, the slider and the changeable resistor are combined to generate the output voltage in the voltage-dividing way at a terminal coupled to the slider.
